(19) United States
(12) Patent Application Publication
(10) Pub. No.: US 2005/0254126 A1
(43) Pub. Date: Nov. 17, 2005

(54) Adjusting apparatus for a telescope system

(75) Inventors: Chi-Shin Lin, Tan-Tzu Hsiang (TW); Shang-Yung Liang, Tan-Tzu Hsiang (TW)

Correspondence Address: MERCHANT & GOULD PC, P.O. BOX 2903, MINNEAPOLIS, MN, 55402-0903, US

(73) Assignee: ASIA OPTICAL CO., LTD., Taichung (TW)

(21) Appl. No.: 10/975,725

(22) Filed: Oct. 27, 2004

(30) Foreign Application Priority Data
May 13, 2004 (TW) 093113395

(51) Int. Cl. G02B 23/00

(52) U.S. Cl. 359/430

(57) ABSTRACT

An adjusting apparatus for a telescopic system includes a base unit, a rotating unit, a resilient member, and an adjusting member. The base unit includes a top wall, a bottom wall, and a surrounding wall, among which an accommodating space is defined. The rotating unit is disposed on the base unit. The resilient member is disposed between and abuts against a positioning section of the rotating unit and one of the top and bottom walls of the base unit so as to bias the positioning section to press against the other of the top and bottom walls, and has at least two circumferentially spaced-apart first contacting portions contacting the positioning section. The adjusting member is mounted threadably on the positioning section. When the rotating unit is rotated, the adjusting member moves axially relative to the base unit.

### CROSS-REFERENCE TO RELATED APPLICATION

This application claims priority of Taiwanese Application No. 093113395, filed on May 13, 2004.

### BACKGROUND OF THE INVENTION

1. Field of the Invention

This invention relates to an adjusting apparatus, and more particularly to an adjusting apparatus for a telescopic system.

2. Description of the Related Art

Referring to FIGS. 1, 2, and 3, a conventional adjusting apparatus for a telescopic system, such as a telescope sight, is used to adjust the position of a riticle 5 (see FIG. 4), and is shown to include a base unit 1, a rotating unit 2, and an adjusting member 3. The base unit 1 includes a base 101, a pressing ring 102, and a limiting member 103. The rotating unit 2 includes a rotating body 201, a cover body 202, a positioning bolt 203, and a spring-biased ball 204. The base 101 having a bottom wall 1011 and a surrounding wall 1012. The pressing ring 102 is mounted threadably on an annular inner surface of the surrounding wall 1012, and has a top opening 1021. The limiting member 103 is mounted threadably on the bottom wall 1011, and has an elliptical limiting hole 1031 formed therethrough. The pressing ring 102, the surrounding wall 1012, and the bottom wall 1011 define an accommodating space 104 (see FIG. 2) thereamong. The rotating body 201 has a positioning section 2011 disposed within the accommodating space 104, a rotating section 2012 extending upwardly from the positioning section 2011 and projecting outwardly from the top opening 1021, an extension section 2013 extending downwardly from the positioning section 2011, and a driving threaded hole 2014 extending from an end surface of the extension section 2013 into the positioning section 2011. The positioning section 2011 has a top annular surface 2015 facing the pressing ring 102, and a bottom annular surface 2106 facing the bottom wall 1011. The cover body 202 has a splined inner surface 2021 (see FIG. 1) engaging a splined outer surface 2017 (see FIG. 1) of the rotating body 201 so as to prevent rotation of the rotating body 201 relative to the cover body 202 while permitting axial movement of the rotating body 201 relative to the cover body 202. The positioning bolt 203 is mounted threadably on the rotating section 2012 so as to prevent the axial movement of the rotating body 201 relative to the cover body 202. The spring-biased ball 204 is disposed on an annular outer surface of the positioning section 2011. The adjusting member 3 has a driven section 301 engaging threadably the driving threaded hole 2014 in the rotating body 201, and an adjusting section 302 extending from the limiting hole 1031 in the limiting member 103. The adjusting section 302 has an elliptical cross-section, and engages fittingly the limiting hole 1031 in the limiting member 103 for preventing relative rotation therebetween while permitting relative axial movement therebetween. When the cover body 202 is rotated, rotation of the rotating body 201 results in axial movement of the adjusting member 3 relative to the base unit 1, which, in turns, moves a barrel that is formed with the riticle 5. Therefore, the position of the riticle 5 can be changed.

Although the aforesaid conventional adjusting apparatus can adjust the position of the riticle 5, it suffers from the following disadvantages:
(1) When an axial gap 6 (see FIG. 2) is formed between the top annular surface 2015 of the positioning section 2011 of the rotating body 201 and the pressing ring 102, the rotating unit 2 will move axially relative to the base unit 1 during adjustment of the position of the riticle 5. As a result, the position of the riticle 5 cannot be adjusted accurately.
(2) When the pressing ring 102 is tightened to engage the top and bottom annular surfaces 2015, 2016 of the positioning section 201 of the rotating body 201 with the pressing ring 102 and an annular shoulder of the bottom wall 1011 of the base 101, respectively, the rotating unit 2 cannot rotate relative to the base unit 1.

Referring to FIG. 5, to solve the above problems, several washers 4 are placed between the top annular surface 2015 of the positioning section 2011 of the rotating body 201 and the pressing ring 102 such that a minimal gap is formed between the lowermost washer 4 and the top annular surface 2015, thereby preventing axial movement of the rotating body 201 relative to the pressing ring 102 while permitting rotation of the rotating boy 201 relative to the pressing ring 102. In actual practice, however, the size of the axial gap 6 is variable due to occurrence of manufacture and machining tolerance. Hence, several tests are performed to determine the number of the washers 4 during assembly. This results in troublesome assembly process. Moreover, the adjusting apparatus of FIG. 5 is disadvantageous in that the cover body 202 is difficult to rotate due to the fact that relatively large friction occurs between the top annular surface 2015 and the washers 4.

### SUMMARY OF THE INVENTION

The object of this invention is to provide an adjusting apparatus for a telescopic system, which can overcome the above-mentioned disadvantages associated with the prior part.

According to this invention, an adjusting apparatus for a telescopic system includes a base unit, a rotating unit, a resilient member, and an adjusting member. The base unit includes a top wall, a bottom wall, and a surrounding wall, among which an accommodating space is defined. The rotating unit is disposed on the base unit. The resilient member is disposed between and abuts against a positioning section of the rotating unit and one of the top and bottom walls of the base unit so as to bias the positioning section to press against the other of the top and bottom walls, and has at least two circumferentially spaced-apart first contacting portions contacting the positioning section. The adjusting member is mounted threadably on the positioning section. When the rotating unit is rotated, the adjusting member moves axially relative to the base unit.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of a conventional adjusting apparatus for a telescopic system;

FIG. 2 is a sectional view of the conventional adjusting apparatus;

FIG. 3 is a schematic sectional view of the telescopic system that is provided with the conventional adjusting apparatus;

FIG. 4 is a sectional view taken along Line IV-IV in FIG. 4, illustrating a riticle;

FIG. 5 is a sectional view of the conventional adjusting apparatus, in which two washers are added;

FIG. 6 is an exploded perspective view of the preferred embodiment of an adjusting apparatus for a telescopic system according to this invention;

FIG. 7 is an exploded sectional view of the preferred embodiment;

FIG. 8 is an assembled sectional view of the preferred embodiment;

FIG. 9 is a sectional view of the telescopic system that is provided with the preferred embodiment; and

FIG. 10 is a sectional view taken along Line X-X in FIG. 9, illustrating a riticle.

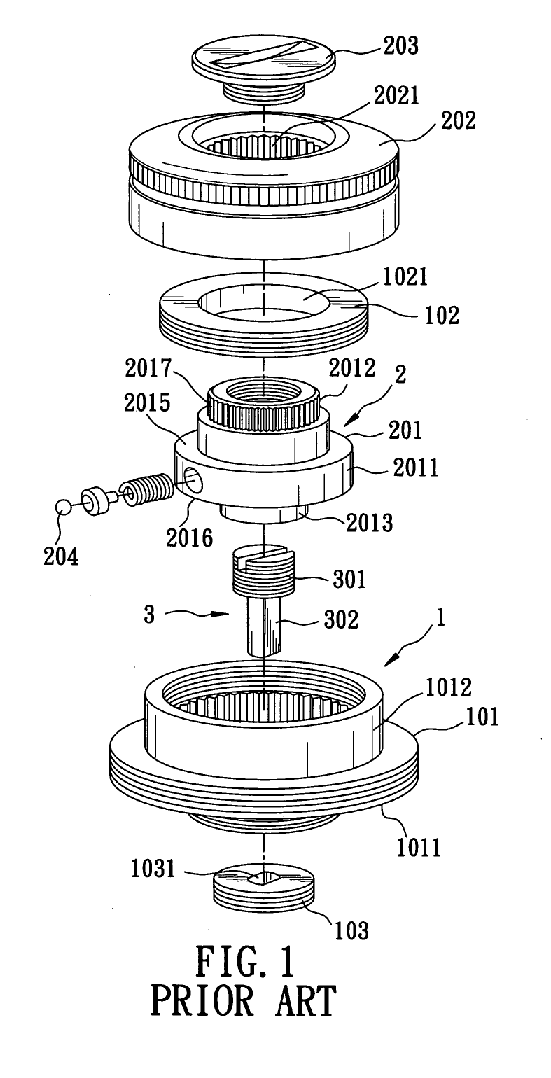

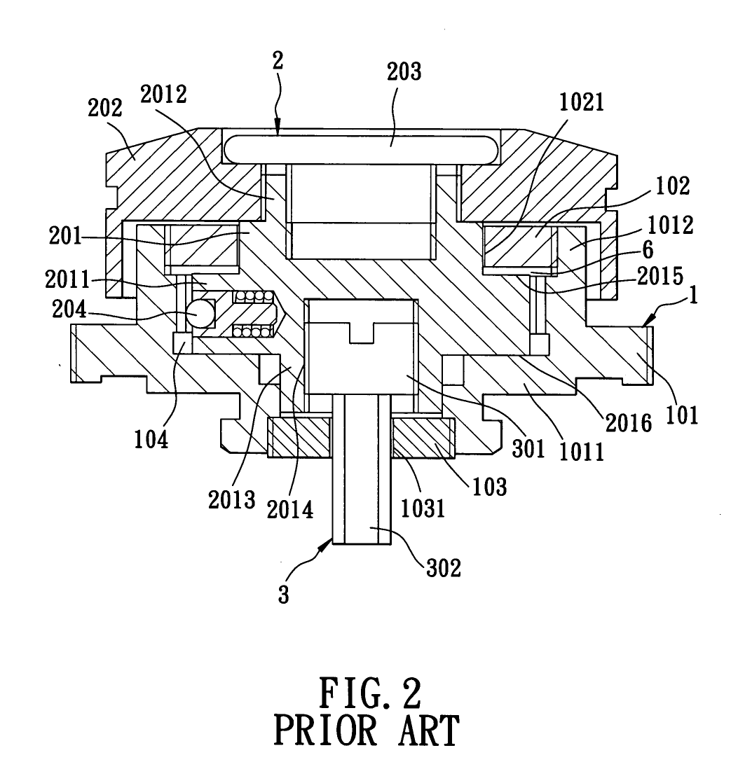

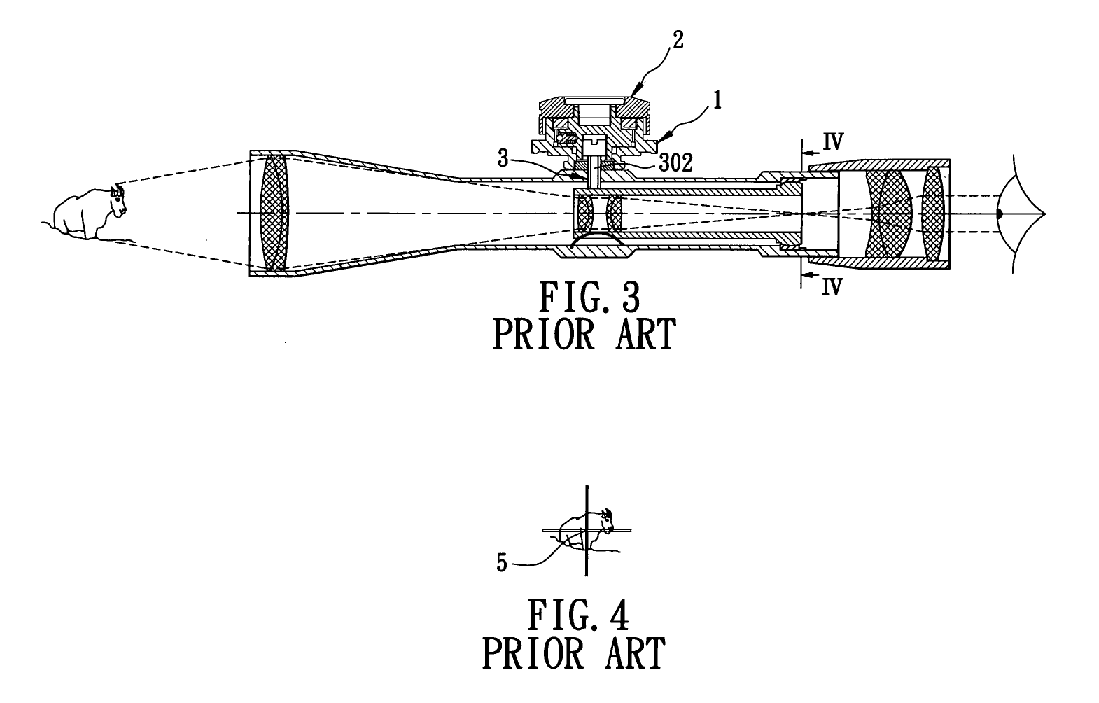

### DETAILED DESCRIPTION OF THE PREFERRED EMBODIMENT

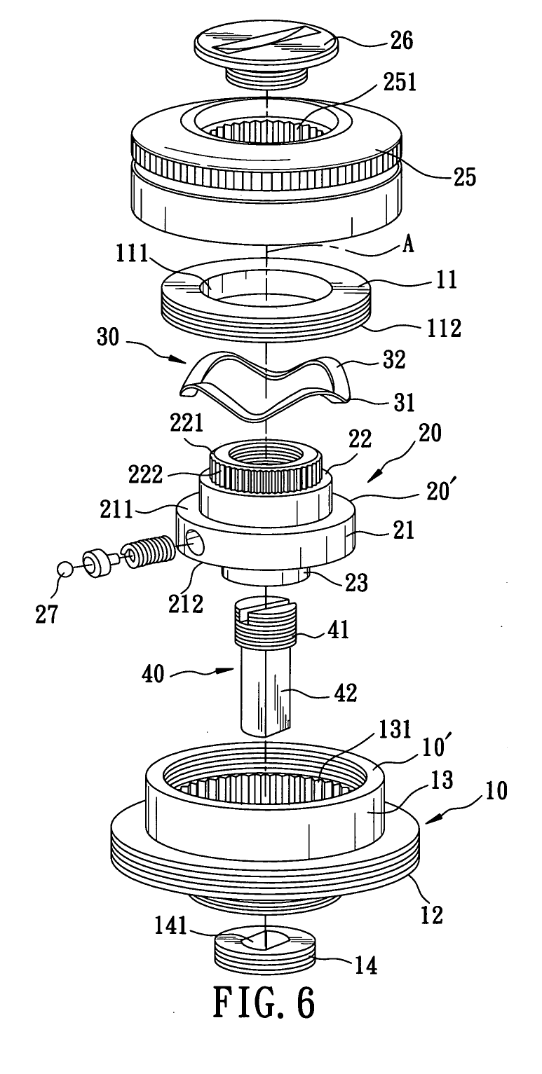

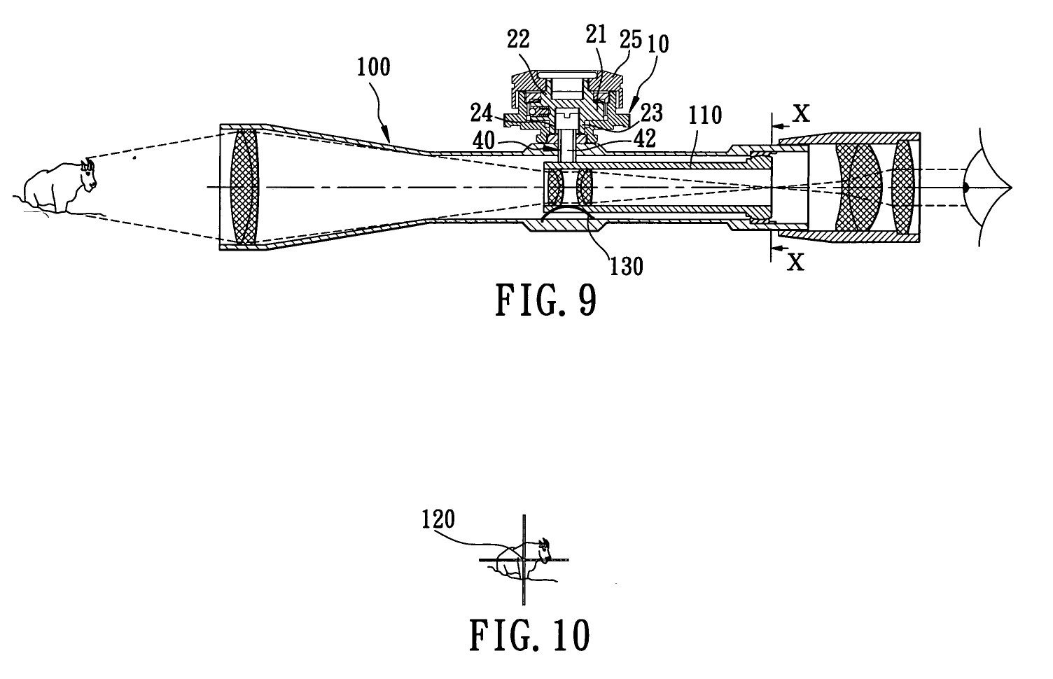

Referring to FIGS. 6, 7, and 8, the preferred embodiment of an adjusting apparatus for a telescopic system 100 (see FIG. 9) according to this invention is shown to include a base unit 10, a rotating unit 20, a resilient member 30, and an adjusting member 40. The telescopic system 100 is configured as a telescope sight, and includes a barrel 110 (see FIG. 9) that is formed with a riticle 120 (see FIG. 10).

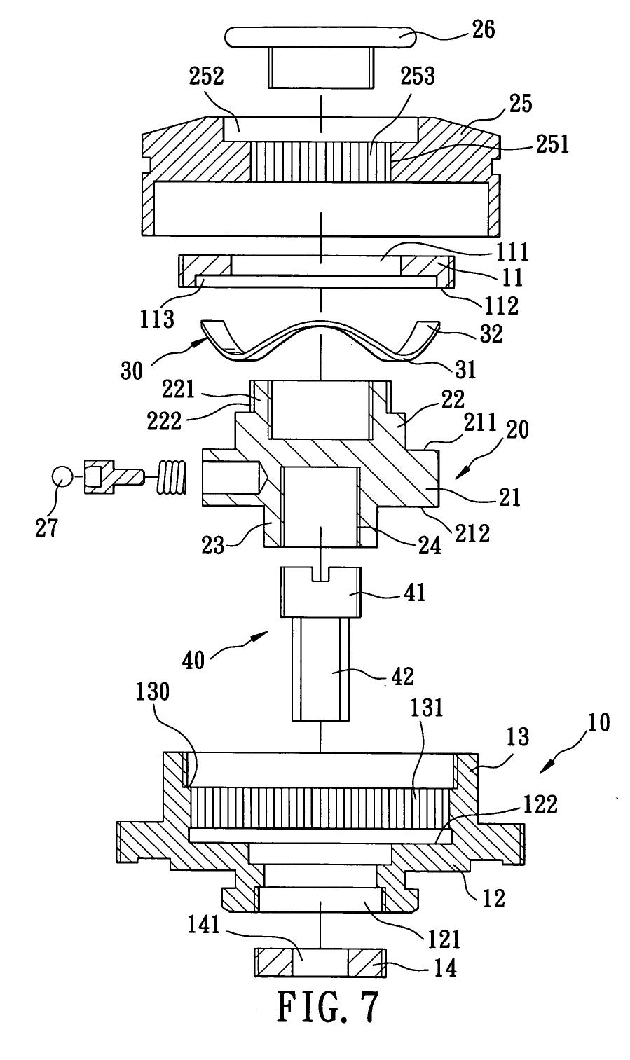

The base unit 10 includes a top wall or pressing ring 11, a bottom wall 12 opposite to the top wall 11, a surrounding wall 13, and a limiting member 14. The surrounding wall 13 interconnects the top and bottom walls 11, 12 to define an accommodating space 15 thereamong. The top wall 11 is mounted threadably on an annular inner surface of the surrounding wall 13, and has a top opening 111 communicated with the accommodating space 15, a bottom surface 112 abutting against a shoulder 130 (see FIG. 7) of the surrounding wall 13 at an outer periphery thereof, and an annular groove 113 formed in the bottom surface 112 and disposed around the top opening 111. The bottom wall 12 has a bottom opening 121 communicated with the accommodating space 15. The bottom wall 12 and the surrounding wall 13 are formed integrally with each other to constitute a base 10′ (see FIG. 6). The surrounding wall 13 has an annular inner surface that is formed with a plurality of axially extending positioning slots 131. The limiting member 14 is mounted threadably within the bottom opening 121 in the bottom wall 12, and has an elliptical limiting hole 141 formed therethrough.

The rotating unit 20 is disposed on the base unit 10, and includes a rotating body 20′ (see FIG. 6), a cover body 25, a positioning bolt 26, and a spring-biased ball 27. The rotating body 20′ has a positioning section 21, a rotating section 22, an extension section 23, and a driving threaded hole 24. The positioning section 21 is disposed within the accommodating space 15 in the base unit 10, and has a top annular surface 211 facing the top wall 11, and a bottom annular surface 212 facing an annular shoulder 122 (see FIG. 7) of the bottomwall 12. The rotating section 22 extends integrally and upwardly from the positioning section 21, is disposed adjacent to the top opening 111 in the top wall 11, and has a top portion 221 that extends from the top opening 111 in the top wall 11 and that has a splined outer surface 222. The extension section 23 extends integrally and downwardly from the positioning section 21 into the bottom opening 121 in the bottom wall 12, and has a bottom end surface distal from the positioning section 21. The driving threaded hole 24 extends from the bottom end surface of the extension section 23 into the positioning section 21. The cover body 25 is annular, and has a splined inner surface 251 engaging the splined outer surface 222 of the top portion 221 of the rotating section 22 of the rotating body 20′ so as to prevent relative rotation therebetween. The positioning bolt 26 is mounted threadably on the top portion 221 of the rotating section 22 of the rotating body 20′ so as to position the cover body 25 relative to the top portion 221, thereby preventing separation of the splined inner surface 251 of the cover body 25 and the splined outer surface 222 of the rotating body 20′. Therefore, the rotating unit 20 can rotate about a rotating axis (A) (see FIG. 6). The spring-biased ball 27 is disposed on an outer surface of the positioning section 21 of the rotating body 20′, and is biased to engage a selected one of the positioning slots 131 in the surrounding wall 13 of the base 10′ so as to position the rotating unit 20 relative to the base unit 10.

The resilient member 30 is disposed within the annular groove 113 in the top wall 11 and between the top wall 11 of the base unit 10 and the top annular surface 211 of the positioning section 21 of the rotating body 20′ so as to bias the bottom annular surface 212 of the positioning section 21 of the rotating body 20′ to press against the annular shoulder 122 of the bottom wall 12 of the base 10′. In this embodiment, the resilient member 30 is configured as a single-turn endless wavy spring, and has four spaced-apart first contacting portions 31 arranged along a circumferential direction of the rotating axis (A) and contacting the top annular surface 211 of the positioning section 21 of the rotating body 20′, and four spaced-apart second contacting portions 32 staggered with respect to the first contacting portions 31 and contacting the top wall 11. Alternatively, the resilient member 30 may be a multi-turn wavy spring or a single-turn wavy spring having two ends.

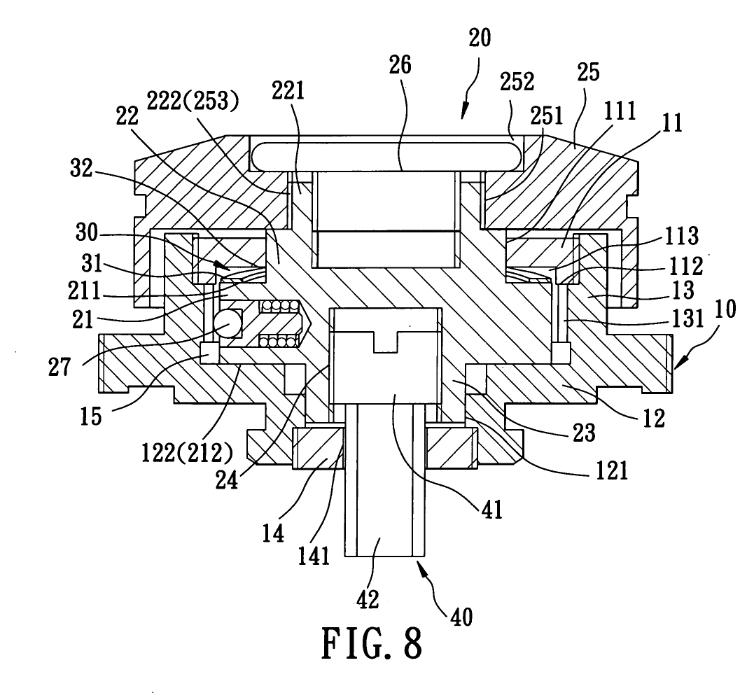

The adjusting member 40 has a driven section 41 engaging threadably the driving threaded hole 24 in the rotating body 20′, and an adjusting section 42 formed integrally with the driven section 41 and extending through and engaging fittingly the limiting hole 141 in the limiting member 14 for preventing rotation of the adjusting member 40 relative to the base unit 10 while permitting movement of the adjusting member 40 relative to the base unit 10 along the rotating axis (A). As a consequence, referring to FIGS. 8, 9, and 10, when the cover body 25 is rotated, rotation of the rotating body 20′ results in axial movement of the adjusting member 40. Hence, the adjusting member 40 moves a barrel of the telescopic system, which is formed with a riticle 120 (see FIG. 10).

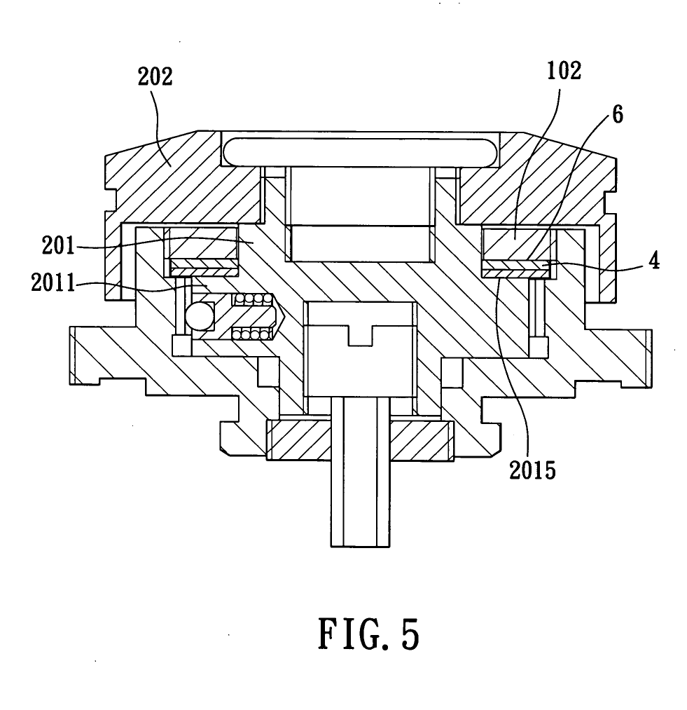

Some of the advantages of this invention can be summarized as follows:
(1) Because the resilient member 30 biases the bottom annular surface 212 of the positioning section 21 of the rotating body 20′ to press against the annular shoulder 122 of the bottom wall 12 of the base 10′, the axial movement of the rotating unit 20 relative to the base unit 10 can be prevented. Therefore, the position of the riticle 120 can be adjusted accurately.
(2) When axial gap formed between the top wall 11 and the top annular surface 211 of the positioning section 21 of the rotating body 20′ is somewhat increased or reduced, the resilient member 30 is capable of producing elastic deformation within the annular groove 113 in the top wall 11 to perform the same function. There is no need for tests, which are necessary for the prior art apparatus of FIG. 5. Thus, the assembly of the adjusting apparatus of this invention can be performed easily.
(3) The resilient member 30 has elastic deformation within the annular groove 113 in the top wall 11. Thus, when he top wall 11 is tightened relative to the base 10′ so that the bottom surface 112 of the top wall 11 abuts against the annular shoulder 130 of the surrounding wall 13 of the base 10′, locking of the positioning section 21 of the rotating body 20′ between the top wall 11 and the base 10′ can be prevented. Thus, the top wall 11 can be positioned easily relative to the base 10′.
(4) Because total contact area between the top annular surface 211 of the positioning section 21 of the rotating body 20′ and the first contacting portions 31 of the resilient member 30 is relatively small, the cover body 25 can be rotated easily.

With this invention thus explained, it is apparent that numerous modifications and variations can be made without departing from the scope and spirit of this invention. It is therefore intended that this invention be limited only as indicated by the appended claims.

1. An adjusting apparatus for a telescopic system, comprising:
a base unit including a top wall, a bottom wall opposite to said top wall, and a surrounding wall interconnecting said top and bottom walls to define an accommodating space thereamong, said top wall having a top opening communicated with said accommodating space, said bottom wall having a bottom opening communicated with said accommodating space;
a rotating unit disposed on said base unit and including a positioning section disposed within said accommodating space in said base unit, and a rotating section connected fixedly to said positioning section and disposed adjacent to said top opening in said top wall of said base unit, said rotating unit being rotatable about a rotating axis;
a resilient member disposed between and abutting against said positioning section of said rotating unit and one of said top and bottom walls of said base unit so as to bias said positioning section of said rotating unit to press against the other of said top and bottom walls of said base unit, said resilient member having at least two first contacting portions that are spaced apart from each other along a circumferential direction of said rotating axis and that contacts said positioning section of said rotating unit; and
an adjusting member having a driven section mounted threadably on said positioning section of said rotating unit, and an adjusting section connected fixedly to said driven section and extending from said bottom opening in said bottom wall of said base unit, said adjusting member being connected to said base unit such that, when said rotating section of said rotating unit is rotated, said adjusting member moves relative to said base unit along said rotating axis.

2. The adjusting apparatus as claimed in claim 1, wherein said base unit further includes a limiting member mounted threadably within said bottom opening in said bottom wall of said base unit and having a non-circular limiting hole formed therethrough, said surrounding wall and said bottom wall of said base unit being formed integrally with each other, said top wall of said base unit being mounted threadably on an annular inner surface of said surrounding wall of said base unit, said adjusting section of said adjusting member extending through and engaging fittingly said limiting hole in said limiting member for preventing rotation of said adjusting member relative to said base unit while permitting movement of said adjusting member relative to said base unit along said rotating axis.

3. The adjusting apparatus as claimed in claim 1, wherein said rotating unit further includes an annular cover body, and a positioning bolt, said rotating section of said rotating unit having a top portion that extends from said top opening in said top wall of said base unit and that has a splined outer surface, said cover body having a splined inner surface engaging said splined outer surface of said top portion of said rotating section of said rotating unit so as to prevent relative rotation therebetween, said positioning bolt being mounted threadably on said top portion of said rotating section of said rotating unit so as to position said cover body relative to said top portion of said rotating section of said rotating unit, thereby preventing separation of said splined inner surface of said cover body and said splined outer surface of said top portion of said rotating section of said rotating unit.

4. The adjusting apparatus as claimed in claim 1, wherein said positioning section of said rotating unit has a top annular surface facing said top wall of said base unit, and a bottom annular surface facing said bottom wall of said base wall, said resilient member being disposed between said top wall of said base unit and said top annular surface of said positioning section of said rotating unit and biasing said bottom annular surface of said positioning section of said rotating unit to press against said bottom wall of said base unit.

5. The adjusting apparatus as claimed in claim 4, wherein said resilient member is configured as a wavy spring, and has four spaced-apart said first contacting portions arranged along the circumferential direction of the rotating axis and contacting said top annular surface of said positioning section of said rotating unit.

6. The adjusting apparatus as claimed in claim 5, wherein said resilient member further has four spaced-apart second contacting portions staggered with respect to said first contacting portions and contacting said top wall of said base unit.

7. The adjusting apparatus as claimed in claim 4, wherein said top wall of said base unit further has a bottom surface that is formed with an annular groove, within which said resilient member is disposed.

8. The adjusting apparatus as claimed in claim 1, wherein said rotating unit further includes:
an extension section connected fixedly to said positioning section and extending into said bottom opening in said bottom wall of said base unit, said extension section having an end surface distal from said positioning section; and
a driving threaded hole extending from said end surface of said extension section into said positioning section and engaging threadably said driven section of said adjusting member.

9. The adjusting apparatus as claimed in claim 1, wherein said surrounding wall of said base unit has an annular inner surface that is formed with a plurality of axially extending positioning slots, said rotating unit further including a spring-biased ball that is disposed on an outer surface of said positioning section and that is biased to engage a selected one of said positioning slots in said inner surface of said surrounding wall of said base unit so as to position said rotating unit relative to said base unit.
